(19) United States
(12) Patent Application Publication
(10) Pub. No.: US 2006/0180550 A1
(43) Pub. Date: Aug. 17, 2006

(54) Portable water purifier

(75) Inventor: George A. Moore III, Raleigh, NC (US)

Correspondence Address: COATS & BENNETT, PLLC, P O BOX 5, RALEIGH, NC, 27602, US

(73) Assignee: Metal & Arsenic Removal Technology

(21) Appl. No.: 11/059,236

(22) Filed: Feb. 16, 2005

(51) Int. Cl. C02F 1/42

(52) U.S. Cl. 210/660

(57) ABSTRACT

A portable water purifier comprises an elongated column having a series of separable sections secured together in end-to-end relationship. Each separable section includes two or more sets of threads that permit the respective sections to be secured together in end-to-end relationship and further enable the individual sections to be reordered. A pair of spaced apart screens is disposed in each section. Defined between the screens is an area for receiving a water treatment composition. The water treatment composition can comprise a variety of materials contained within a porous container disposed between the pair of screens in the respective sections of the column.

### FIELD OF THE INVENTION

The present invention relates to portable water purifiers, and more particularly to a portable water purifier that includes a plurality of separable sections with one or more of the sections including a water treating composition.

### BACKGROUND OF THE INVENTION

Drinking water in many geographical areas, and particularly in underdeveloped countries, is not safe for drinking. In these areas water is often contaminated with nitrogen based compounds, suspended solids, bacteria, viruses, odor, and even in some cases arsenic.

Processes are known for purifying water for drinking. Early purification processes revolved around boiling contaminated water. Since then, it has been common to add certain chemicals to water for purifying the same. These early rudimentary processes have many shortcomings. Over time, water purification systems were developed to remove contaminants. These water filtration systems directed untreated water through a filter and contaminants were filtered therefrom in the process. In the past, many filtering mediums have utilized felt or cloth. See the disclosures in U.S. Pat. Nos. 4,477,347 and 53,606. As described in U.S. Pat. No. 4,477,347, the art has developed considerably over the years and filters utilizing spun or wrapped filters in a cylinder shape having water passed radially through the cylinder from the outside to an inside hollow area have been developed.

As the water purification art has evolved and developed over the years, many other filtering processes have been employed. Activated carbon has been used as a filtering medium. Further, plastic mesh has been used to remove very small particulate matter from drinking water.

It is also known to provide small, portable water purifying units. These are typically used by individuals that hike or camp, and can be used by individuals visiting regions or countries where the water quality is suspect. For example, handheld portable water purifiers are disclosed in U.S. Pat. Nos. 4,389,311; 4,990,254; and 4,477,347. However, portable water purifiers of the prior art have a number of drawbacks. In many cases their effectiveness is limited. That is, portable water purifiers of the prior art are not designed to remove a wide range of contaminants, and certainly are not generally designed to remove the more harsh and dangerous contaminants such as arsenic. Further, their structure and design is aimed at a particular contaminant or a small group of contaminants. Their designs are not sufficiently flexible to enable the user to adapt the portable water purifier to efficiently remove a wide range of contaminants.

### SUMMARY OF THE INVENTION

The present invention entails a portable water purifier for filtering or treating water comprising a column. A plurality of water treating compositions are contained within the column with one water treating composition being disposed over another water treating composition.

In one embodiment of the present invention, the portable water purifier comprises a plurality of stacked sections that are secured together in end-to-end relationship. Each section is adapted to receive and hold a water treating composition. Because the individual sections are detachably secured together, the respective sections can be reordered to accommodate a particular process sequence.

Further, the present invention entails a method for treating drinking water with a portable water purifier. This method entails pouring untreated water into the top of the column forming a part of the portable water purifier where the column comprises a plurality of separable sections. Once the water is poured into the top of the column, the water flows through the individual sections of the column and over a plurality of different water treatment compositions contained within the respective sections. Once the water has passed through the respective sections of the column, the treated water is directed through an outlet formed in the portable water purifier.

Other objects and advantages of the present invention will become apparent and obvious from a study of the following description and the accompanying drawings, which are merely illustrative of such invention.

### BRIEF DESCRIPTION OF THE DRAWINGS

FIG. 1 is a perspective view showing the portable water purifier of the present invention in an operative position.

FIG. 2 is an exploded perspective view of the portable water purifier.

FIG. 3 is a vertical sectional view taken through the lines 3-3 of FIG. 1.

FIG. 4 is a sectional view similar to FIG. 3, but with the portable purifier assuming a closed or transport mode.

FIG. 5 is a perspective view of an another design for the portable water purifier of the present invention.

FIG. 6 is a sectional view of the water purifier of FIG. 5.

### DESCRIPTION OF EXEMPLARY EMBODIMENT

With further reference to the drawings, the portable water purifier is shown therein and indicated generally by the numeral 10. The portable water purifier 10 is of a compact design and is of a size that will permit individuals to carry the same while on a camping or hiking trip, or while generally traveling. Device 10 is referred to as a water purifier. The term purifier is to be given a broad interpretation and encompasses a device that treats, filters or conditions water. More particularly, water purifier 10 is especially adapted to purify or treat drinking water.

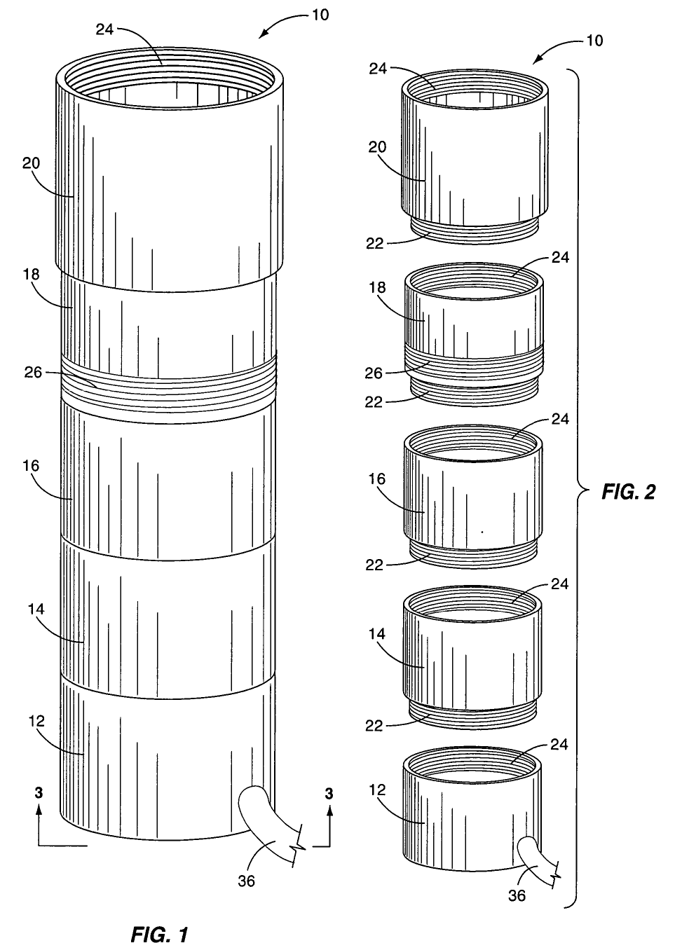

Viewing portable water purifier 10 in more detail, as shown in the drawings, the same comprises an elongated column that is made up of a plurality of separable sections. The separable sections are provided with some means to secure them in end-to-end relationship. As will be appreciated from subsequent portions of the disclosure, when the respective separable sections are secured together, the internal area extending through the sections is open and permits the flow of water from a top portion of the column, down through the column and out an outlet formed about the lower portion of the column. In the embodiment illustrated herein, the water purifier 10 is of the gravity type. That is, in an operative mode the portable water purifier 10 is disposed as shown in FIG. 1 and water is poured through the top thereof and allowed to move, via gravity, downwardly through the respective sections and out an outlet disposed in the lower portion thereof.

The number of sections comprising the column can vary. In the case of the embodiment illustrated herein, the portable water purifier 10 includes five cylindrical sections that are referred to by the numerals 12, 14, 16,18 and 20. As seen in FIG. 1, section 12 assumes the bottom portion of the column, while section 20 assumes the top portion of the column. While the shape or configuration of the individual sections can vary, in the case of the embodiment illustrated herein, the respective separable sections are cylindrical in shape. That is, they include an outer cylindrical wall and an open interior area defined within the wall structure. The respective sections that make up the column of the water purifier 10 can be constructed of various materials. However, it is contemplated that the respective sections would be constructed of high-density plastic that will withstand a 15 mph drop.

Most, if not all, of the sections 12, 14, 16, 18 and 20 include an indented lower portion. Formed on the indented lower portion is an exterior set of threads 22. Formed about the upper portion of each section is an interior set of threads 24. These two sets of threads enable the respective sections to be secured together in end-to-end relationship. As seen in FIG. 2, the exterior set of threads 22 of section 14 are operative to be threadedly engaged into the interior set of threads 24 formed in the upper portion of the lower most section 12. Likewise, section 16 couples to section 14, section 18 couples to section 16, and section 20 couples to section 18.

In addition, one section can include an extra set of exterior threads. In this particular case, section 18 is provided with an exterior set of threads 26. These threads are disposed around the main body of the cylindrical wall just above the exterior set of threads 22. As will be appreciated from subsequent portions of the disclosure, this extra set of threads 26 function to cap and secure the portable water purifier 10 when the same is not being used and when it assumes a carrying or transport state.

Each section is designed to contain or hold a water treating composition. In the case of this embodiment, each section is provided with a pair of screens 28. Screens 28 are axially spaced apart and define a containment area 30 therebetween. Screens 28 can be of a various mesh size. However, in one embodiment, it is contemplated that the screens 28 would be approximately 200 mesh and constructed of stainless steel. As noted above, the portable water purifier 10 is adapted to hold a series of different water treatment compositions. Herein the term “water treatment composition” is meant to entail and include any material or chemical that filters, purifies or treats water. Various examples of water treatment compositions will be described subsequently herein.

In any event, each water treatment composition is housed or contained within a porous container 32. Various types of porous containers can be utilized. They may include filter pillows or a porous container such as a tea bag structure. As illustrated in the drawings, such a container can be placed in the containment area 30 defined between the pair of screens 28. It should be noted that at least one of the screens 28 in each section could be removed from the section to gain access to the containment area 30. This would prove useful in cases where it is desired to retrieve the container 32 with the water treatment composition to either discard the same, refill the container, or rejuvenate the water treatment composition contained therein.

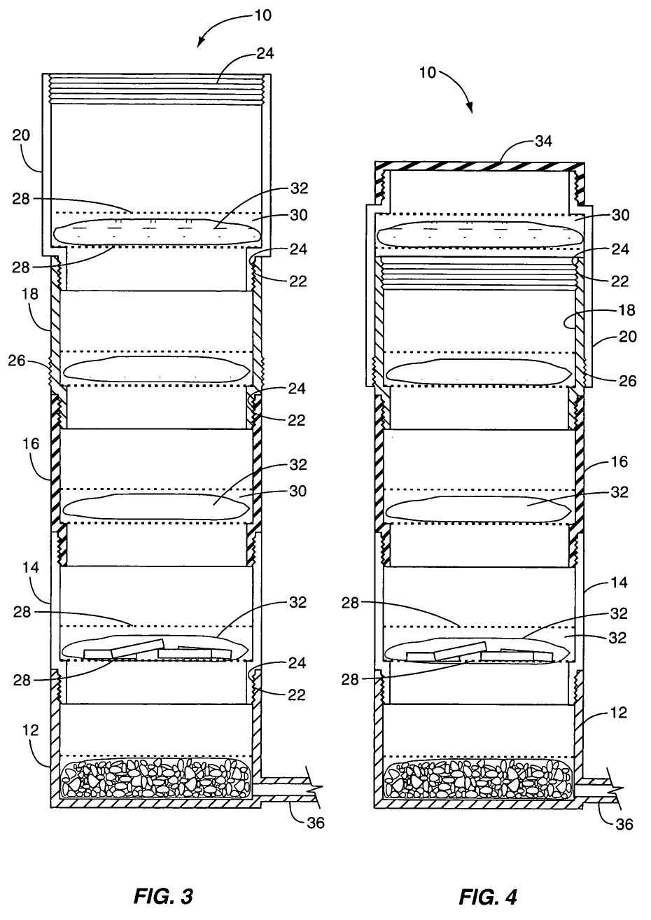

As discussed above, one or more of the sections that form the column can be adapted to close the water purifier 10 for carrying or transport. FIG. 3 illustrates the water purifier 10 in an open and operative position. In this case, water is poured into the top of upper section 20 and allowed to gravitate downwardly through the respective sections. In the process, the water will be filtered, decontaminated, cleaned or otherwise treated as it passes through the porous containers 32 and comes into contact with the respective treating compositions confined within the containers 32. Note that the lowest most section, section 12, is provided with an outlet 36. This outlet will expel purified or cleaned water.

To convert the water purifier 10 from an operative purifying configuration, as shown in FIG. 3, to a carrying or transport configuration, as shown in FIG. 4, the upper section 20 is unscrewed from section 18. Next, the upper section 20 is inverted such that the interior threads 24 of the upper section 20 can be screwed on to the extra set of exterior threads 26 of section 18. Next, a cap 34 can be screwed onto the exterior threads 22 of the upper section 20. This closes the column and transforms the water purifier 10 into a device that can be easily carried and transported from location to location.

The portable water purifier 10 aims to remove bacteria, viruses and toxins from water. Various water treating compositions can be utilized within the individual sections of the purifier 10. One water treating composition contemplated to be used is zeolite. Zeolite can be housed or contained within one of the porous containers 32 and would function as a filtering media and would also function to partially remove ions. In one embodiment, it is contemplated that the zeolite would be provided in pellet form and approximately 150 mesh size, which would allow an adequate flow of water therethrough and provide sufficient contact time in a gravity flow situation for the removal of nitrogen based compounds. This size zeolite would also allow for the removal of suspended solids from the water.

Additionally, another water treating composition that can be used in a respective section of the water purifier is ARTI-64. ARTI-64 will remove arsenic as As₃ and As₅ from the drinking water passing therethrough. Another water treating composition that is suitable for use in the water purifier 10 is a mixed bed resin. A mixed bed resin will remove remaining cat ions from the water. Further, the water treating compositions can include bromine or chlorine. These compounds or substances are useful to kill bacteria and viruses. In cases where the pH values in the water exceed 8.2, it is contemplated that bromine should be utilized in lieu of chlorine.

Finally, the waste treatment composition may include activated carbon. Activated carbon will function to remove organics, VOC, chlorine, bromine, odors and contaminants that cause the water to have an unpleasant taste.

The water treating compositions just described can be ordered or staged in various sections of the water purifier 10. In one example, in the operative state, as shown in FIG. 3, the upper section 20 would include zeolite. Under the zeolite section, section 18 would include ARTI-64. The third section from the top, section 16, would include a mixed bed resin. Underneath the mixed bed resin, there could be a composition of bromine or chlorine. Finally, thereunder and in the bottom section 12 would be activated carbon.

One advantage of the water purifier 10 of the present invention is that the sections, and consequently the water treatment compositions, can be reordered. For example, in some cases it might be desirable for one section to assume the top position in the column when treating one type of water, and the next to the bottom position when treating another type of water. The user can easily reorder or restage water treatment compositions by simply unscrewing the respective sections and then connecting them together in a particular configuration.

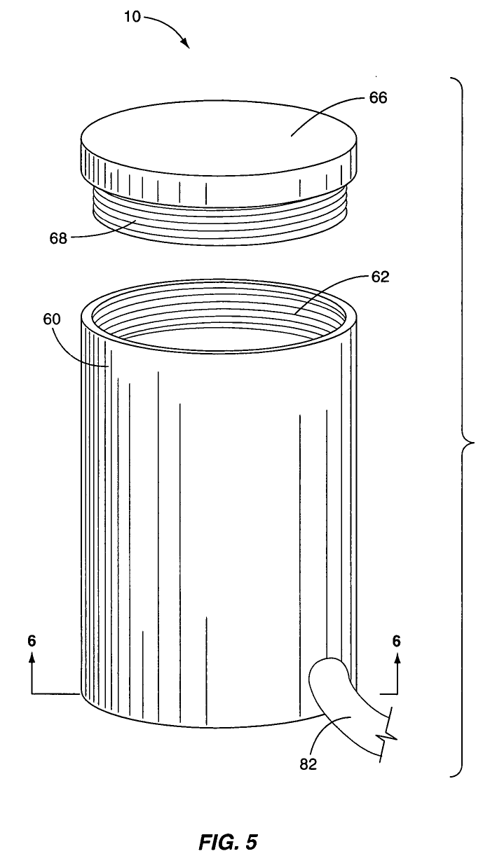

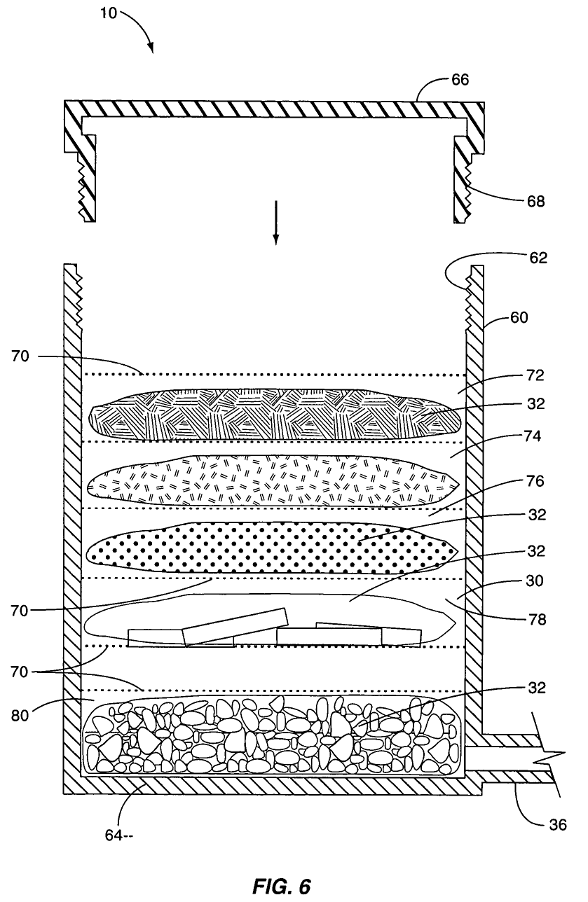

With reference to FIGS. 5 and 6, there is shown therein another design for the portable water purifier. This design is indicated generally by the numeral 10. Viewing this design in more detail, the same includes a cylindrical section 60. Formed internally about the upper portion of the cylindrical section 60 is a set of internal threads 62. Cylindrical section 60 includes a bottom 64 and a top 66. Top 66 includes a set of external threads 68.

Disposed internally within the cylindrical section 60 is a series of screens 70. Screens 70 are vertically spaced apart and define a series of compartments 72, 74, 76, 78 and 80. Screens 70 can be designed to be removably contained within the cylindrical section. That is, the respective screens 70 can be designed to snap into and out of the cylindrical section.

Extending from the bottom compartment 80 is an outlet 82. As is appreciated from the drawings, water directed into the top of cylindrical section 60 will flow downwardly through the cylindrical section 60 and through the various compartments therein and out the outlet 82.

As with the embodiment discussed above, each water treatment composition is housed or contained within a porous container 32. This may include filter pillows or a porous container such as a tea bag structure. As illustrated in FIG. 6, containers 32 can be placed within the compartments defined between respective screens 70.

As discussed above, the water treatment compositions could include zeolite and cupric oxide. One form of cupric oxide is known as “ARTI-64.” In some cases the cupric oxide could be bonded with zeolite. In addition to zeolite and cupric oxide, the water purifier 10 is designed to receive and hold a mixed bed resin, bromine or chlorine, and activated carbon. In each case, each respective water treatment composition can be housed or contained within a porous container 32. In one example, as shown in FIG. 6, the upper compartment 72 would be provided with zeolite contained within the container 32. Under the zeolite section, there would be provide cupric oxide. The third section from the top, or compartment 76, would include a mixed bed resin. Underneath the mixed bed resin, there could be a composition of bromine or chlorine. Finally, the bottom compartment 78 would include activated carbon.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. A portable water purifier for filtering and treating water, comprising: a column having a plurality of separable sections secured together; a plurality of different water treating compositions contained within the column with one water treating composition disposed in one section and another water treating composition disposed in another section.

2. The portable water purifier of claim 1 including at least two water treating compositions selected from the group consisting of zeolite, ARTI-64, mix bed resin, bromine or chlorine, and activated carbon.

3. The portable water purifier of claim 1 wherein respective sections of the column are provided with threads that permit one section to be threadedly secured to another.

4. The portable water purifier of claim 1 wherein one or more of the sections includes a pair of spaced apart screens.

5. The portable water purifier of claim 4 wherein the water treating compositions are contained within a porous container, and wherein respective porous containers are disposed in a respective section between the spaced apart screens.

6. The portable water purifier of claim 1 wherein the column includes a top and a bottom and the water treating compositions are ordered from the top to the bottom to include zeolite in one section, an arsenic removal composition in another section disposed below the section having the zeolite, a mixed resin disposed in one section below the arsenic removal composition, a bromine or chlorine composition disposed in one section below the mixed bed resin, and activated carbon disposed in one section below the zeolite.

7. The portable water purifier of claim 1 wherein the column comprises a plurality of cylindrical sections.

8. The portable water purifier of claim 7 wherein each of at least two of the cylindrical sections includes two sets of threads, an internal set of thread and an external set of thread.

9. The portable water purifier of claim 1 wherein the column includes a top and a bottom and wherein disposed about the top of the column is a top section that includes an opening that permits water to be poured therein such that the water entering the top section moves by gravity through the respective sections and the water treating compositions disposed therein.

10. The portable water purifier of claim 9 including a screw on top for screwing on to the top section.

11. The portable water purifier of claim 1 wherein the column includes a top and a bottom and the column includes a top section and a bottom section with the bottom section including an outlet through which water flows after the water has moved through the column and the water treating compositions within the respective sections.

12. A portable water purifier comprising: an elongated column having a plurality of separable sections with one section being detachably secured to another section; a pair of spaced apart screens formed in each section with the screens in each section defining an area therebetween for receiving a water treating composition; and wherein the water treating compositions include at least three compositions selected from the group consisting of zeolite, ARTI-64, mixed bed resin, bromine or chlorine, and activated carbon.

13. The portable water purifier of claim 12 wherein each separable section comprises a cylindrical section having two sets of threads.

14. The portable water purifier of claim 12 wherein the column includes a top portion and a bottom portion and wherein the respective separable sections can be reordered from top to bottom so as to vary the order of the water treating compositions from top to bottom.

15. A method of purifying water for drinking with a portable water purifier comprising:
a. pouring water to be treated into the top of a column forming a part of the portable water purifier where the column comprises at least three separable sections secured in end-to-end relationship;
b. directing the water by gravity downwardly through the plurality of separable sections and over a plurality of different water treatment compositions where each water treatment composition is contained in a separate section; and
c. directing the treated water out an outlet formed in the column.

16. The method of claim 15 including directing the water into contact with three or more water treatment compositions taken from the group consisting of zeolite, ARTI-64, mixed bed resin, bromine or chlorine, and activated carbon.

17. The method of claim 16 including directing the water through a series of different water treatment compositions arranged in the following order: zeolite, ARTI-64, mixed bed resin, bromine or chlorine, and activated carbon.

18. The method of claim 17 including removing nitrogen based compounds and suspended solids from the water.

19. The method of claim 18 including removing arsenic from the drinking water.

20. The method of claim 19 including directing the water into contact with activated carbon that is operative to remove organics, VOC, chlorine, bromine, or odors.

21. A portable water purifier comprising an elongated cylindrical column having at least three separable sections that are joined end-to-end to form the column; at least one of the sections having two sets of threads and wherein each of the respective sections include at least one set of threads such that the three sections can be threadedly secured together in end-to-end relationship; each section having a pair of transversely extending screens that are axially spaced apart and supported within the section, each pair of screens defining a confinement area for receiving and holding a water treating composition.

22. The portable water purifier of claim 21 further including three separate water treating compositions contained within the column, with each water treating composition confined within a porous container with each porous container disposed between the two screens of each section.

23. The portable water purifier of claim 22 wherein the three separate water treating compositions are selected from the group consisting of zeolite, ARTI-64, mixed bed resin, bromine or chlorine, and activated carbon

24. A portable water purifier comprising a column having at least three separate water treating compositions contained therein with each water treating composition contained within a porous container; and wherein the respective water treating compositions are disposed one over the other and are taken from the group consisting of zeolite, cupric oxide, mixed bed resin, bromine or chlorine, and activated carbon.

25. The portable water purifier of claim 24 wherein the column includes a plurality of vertically spaced screens with pairs of the respective screens forming compartments for holding the water treatment compositions.

26. The portable water purifier of claim 25 wherein the respective screens are removable from the column such that one or more of the water treatment compositions can be replaced.

27. The portable water purifier of claim 24 wherein the column includes five separate water treatment compositions including zeolite, cupric oxide, mixed bed resin, bromine or chlorine, and activated carbon.

28. The portable water purifier of claim 27 wherein the water treatment compositions are ordered such that the zeolite composition is disposed in an upper portion of the column and the activated carbon is disposed about the lower portion of the column.

29. The portable water purifier of claim 28 wherein the cupric oxide is disposed between the zeolite and the activated carbon.
